(19) United States
(12) Patent Application Publication
(10) Pub. No.: US 2017/0243173 A1
(43) Pub. Date: Aug. 24, 2017

(54) Systems and Methods for Managing Information Related to Transactions

(71) Applicant: Coin Out Inc., New York, NY (US)

(72) Inventor: Jeffrey WITTEN, New York, NY (US)

(21) Appl. No.: 15/436,276

(22) Filed: Feb. 17, 2017

Related U.S. Application Data
(60) Provisional application No. 62/297,597, filed on Feb. 19, 2016.

(51) Int. Cl. G06Q 20/02; G06Q 20/10; G06Q 20/20

(52) U.S. Cl. CPC G06Q 20/023; G06Q 20/202; G06Q 20/10

(57) ABSTRACT

Systems and methods for transferring and storing information related to a transaction are disclosed. For example, a first request can be received to store a first amount of money related to a first transaction between a user and a first merchant. The first amount of money can be based on first change due to the user from the first transaction. A second request can also be received to store a second amount of money related to a second transaction between the user and a second merchant. The second amount of money can be based on second change due to the user from the second transaction. A balance of money can include a sum of the first amount of money and the second amount of money. A transfer of the balance of money from a for benefit of (FBO) account to a destination can be instructed.

### RELATED APPLICATION

This application claims benefit under 35 U.S.C. §119(e) to U.S. Provisional Patent Application No. 62/297,597, filed on Feb. 19, 2016, titled “Systems and Methods for Remitting and Storing Cash Change in Digital Format,” which is explicitly incorporated by reference herein in its entirety.

### BACKGROUND OF THE INVENTION

Technical Field

Embodiments of the present disclosure relate to the field of transferring, storing, and pooling information related to transactions.

Description of the Related Art

Transactions between merchants and customers can be classified into a number of different types of transactions: (1) card-based, (2) bank-based, or (3) cash-based. In the card-based and bank-based transactions, a customer uses a card or bank-enabled device to pay for goods. These transactions deliver money into the hands of the payee through any of the credit, debit, prepaid, or banking payments infrastructure. For those transactions, the amount owed by the payor (customer) to the payee (merchant) may not end up in a whole dollar amount (e.g., $5.67 for a sandwich). Because of the way these payments are processed, the exact dollar amount (e.g., $5.67) can be transmitted to the merchant in one transaction, as the payment methods can be charged or delivered in increments of 1 cent. In cash-based transactions, there are usually two steps. If the transaction is not a whole dollar amount (e.g., $5.67), then a cash-paying customer will normally tender a larger dollar amount (e.g., $10), and then receive change in bills and/or coins (e.g., 4 dollars and 33 cents).

Many customers that use cash do not use their change effectively partly because there has been limited innovation around saving physical change or spending it easily. Many lose change by its sheer nature; coins and loose bills have never been a good repository of value because of their size, weight, and portability. Some will donate portions of their change for tips or leave it in a container home. The only main solution around this problem has been a coin conversion kiosk. These kiosks allow customers to dump their change into a machine that counts the total value of the change and returns to the customer larger bills or a gift card with the requisite value. They are usually positioned in grocery stores, charging customers up to 11% to convert to cash. Many banks had offered this service for free, but over the past decade, almost all of them have eliminated this service.

There has been some innovation regarding the loose change concept, albeit indirectly. For example, Bank of America created a marketing program called “Keep the Change.” This program was targeted at individuals with a checking account, and encouraged them to open a savings account. If an individual signed up, with a purchase based on a card-based transaction, Bank of America would round up the purchase to the nearest dollar (e.g., $5.67 transaction would be rounded up to 6 dollars), and move the residual from the individual's checking account to his or her savings account. However, the program was limited to card-based transactions and to those customers that had accounts with Bank of America. Bank of America subsequently stopped this program.

A more recent example is Acorns, a company that charges a customer's registered card the “change” amount from a transaction and puts the excess change into an investment account. However, the cash-based transactions have not been improved in such a way, where loose change is actually central to the interaction between payor and payee. This is largely because cash-based transactions are restricted in that they are not linked to a digital instrument (e.g., a credit card), and require cooperation and integration across a number of different institutional parties.

Moreover, many of the individuals that use cash do not have access to the financial system. The fees on coin conversion and carrying excess cash is abnormally high, and serves as an effective regressive tax on individuals of lower income. Further, because there has not been a digital connection between cash and the online world, cash users have reduced purchasing power and limited access to many goods online that are sold at discounts or better prices than traditional brick and mortar locations.

Therefore, there is a need in the art to provide systems, methods, and computer readable media for making cash transactions more efficient.

### SUMMARY

In accordance with the disclosed subject matter, systems, methods, and computer readable media are provided for transferring, storing, and pooling information related to transactions.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

A method of transferring and storing information related to a transaction according to one embodiment of the present disclosure can include receiving, at a server from a first Point of Sale (POS) device, a first request to store a first amount of money related to a first transaction between a user and a first merchant, wherein the first request includes user identification information uniquely associated with the user, and wherein the first amount of money is equal to or less than first change due to the user from the first transaction; associating, at the server, the first amount of money with a user account based on the user identification information; receiving, at the server from a second POS device, a second request to store a second amount of money related to a second transaction between the user and a second merchant, wherein the second request includes the user identification information, and wherein the second amount of money is equal to or less than second change due to the user from the second transaction; associating, at the server, the second amount of money with the user account based on the user identification information; calculating, at the server, a balance of money associated with the user account, wherein the balance of money includes a sum of the first amount of money and the second amount of money; receiving, at the server, a user request to use the balance of money or a subset of the balance of money, wherein the user request includes a destination to receive the balance of money or the subset of the balance of money; and instructing, from the server, a transfer of the balance of money or the subset of the balance of money from a for benefit of (FBO) account to the destination.

According to some embodiments, the method can further include transmitting, from the server, data for generating a receipt associated with at least the first request to store the first amount of money or the second request to store the second amount of money.

According to some embodiments, the receipt can be in a form of at least one of an email or a text message.

According to some embodiments, the method can further include calculating, at the server, an updated balance of money associated with the user account, wherein the updated balance of money is the balance of money subtracted by the balance of money or the subset of the balance of money that is transferred.

According to some embodiments, the transfer from the FBO account to the destination can be performed using Automated Clearing House (ACH).

According to some embodiments, the user identification information can be based on user input at the first POS device or the second POS device.

According to some embodiments, the user input can include a phone number.

According to some embodiments, the first merchant and the second merchant can be the same.

According to some embodiments, the first merchant and the second merchant can be different.

According to some embodiments, the first POS device and the second POS device can be the same.

According to some embodiments, the first POS device and the second POS device can be different.

A method of pooling money from one or more users making transactions with one or more merchants according to one embodiment of the present disclosure can include receiving, at a server from a first POS device of a merchant, a first request to store a first amount of money related to a first transaction between a first user and the merchant, wherein the first request includes first user identification information uniquely associated with the first user, wherein the first amount of money is equal to or less than first change due to the first user from the first transaction, and wherein the first request is received within a predetermined period; associating, at the server, the first amount of money with a first user account based on the first user identification information; receiving, at the server from a second POS device of the merchant, a second request to store a second amount of money related to a second transaction between a second user and the merchant, wherein the second request includes second user identification information uniquely associated with the second user, wherein the second amount of money is equal to or less than second change due to the second user from the second transaction, and wherein the second request is received within the predetermined period; associating, at the server, the second amount of money with a second user account based on the second user identification information; and instructing, from the server, a merchant bank to transfer a sum of money to a partner bank, wherein the sum of money includes the first amount of money and the second amount of money.

According to some embodiments, the sum of money can be stored at an FBO account of the partner bank.

According to some embodiments, the transfer from the merchant bank to the partner bank can be performed using ACH.

According to some embodiments, the first POS device and the second POS device can be the same.

According to some embodiments, the first POS device and the second POS device can be different.

According to some embodiments, the method can further include receiving, at the server from a third POS device of a second merchant, a third request to store a third amount of money related to a third transaction between the first user and the second merchant, wherein the third request includes the first user identification information, and wherein the third amount of money is equal to or less than third change due to the first user from the third transaction; and associating, at the server, the third amount of money with the first user account based on the first user identification information.

According to some embodiments, the merchant and the second merchant can be the same.

According to some embodiments, the merchant and the second merchant can be different.

According to some embodiments, the method can further include calculating, at the server, a balance of money associated with the first user account, wherein the balance of money includes a sum of the first amount of money and the third amount of money; receiving, at the server, a user request to use the balance of money or a subset of the balance of money, wherein the user request includes a destination to receive the balance of money or the subset of the balance of money; instructing, from the server, a transfer of the balance of money or the subset of the balance of money from the FBO account to the destination; and calculating, at the server, an updated balance of money associated with the first user account, wherein the updated balance of money is the balance of money subtracted by the balance of money or the subset of the balance of money that is transferred.

A server for transferring and storing information related to a transaction according to one embodiment of the present disclosure can include a memory that stores a module; and a processor configured to run the module stored in the memory that is configured to cause the processor to: receive, from a first POS device, a first request to store a first amount of money related to a first transaction between a user and a first merchant, wherein the first request includes user identification information uniquely associated with the user, and wherein the first amount of money is equal to or less than first change due to the user from the first transaction; associate the first amount of money with a user account based on the user identification information; receive, from a second POS device, a second request to store a second amount of money related to a second transaction between the user and a second merchant, wherein the second request includes the user identification information, and wherein the second amount of money is equal to or less than second change due to the user from the second transaction; associate the second amount of money with the user account based on the user identification information; calculate a balance of money associated with the user account, wherein the balance of money includes a sum of the first amount of money and the second amount of money; receive a user request to use the balance of money or a subset of the balance of money, wherein the user request includes a destination to receive the balance of money or the subset of the balance of money; and instruct a transfer of the balance of money or the subset of the balance of money from an FBO account to the destination.

According to some embodiments, the module stored in the memory can be further configured to cause the processor to transmit data for generating a receipt associated with at least the first request to store the first amount of money or the second request to store the second amount of money.

According to some embodiments, the receipt can be in a form of at least one of an email or a text message.

According to some embodiments, the module stored in the memory can be further configured to cause the processor to calculate an updated balance of money associated with the user account, wherein the updated balance of money is the balance of money subtracted by the balance of money or the subset of the balance of money that is transferred.

According to some embodiments, the transfer from the FBO account to the destination can be performed using ACH.

According to some embodiments, the user identification information can be based on user input at the first POS device or the second POS device.

According to some embodiments, the user input can include a phone number.

According to some embodiments, the first merchant and the second merchant can be the same.

According to some embodiments, the first merchant and the second merchant can be different.

According to some embodiments, the first POS device and the second POS device can be the same.

According to some embodiments, the first POS device and the second POS device can be different.

A server for pooling money from one or more users making transactions with one or more merchants according to one embodiment of the present disclosure can include a memory that stores a module; and a processor configured to run the module stored in the memory that is configured to cause the processor to: receive, from a first POS device, a first request to store a first amount of money related to a first transaction between a first user and a merchant, wherein the first request includes first user identification information uniquely associated with the first user, wherein the first amount of money is equal to or less than first change due to the first user from the first transaction, and wherein the first request is received within a predetermined period; associate the first amount of money with a first user account based on the first user identification information; receive, from a second POS device, a second request to store a second amount of money related to a second transaction between a second user and the merchant, wherein the second request includes second user identification information uniquely associated with the second user, wherein the second amount of money is equal to or less than second change due to the second user from the second transaction, and wherein the second request is received within the predetermined period; associate the second amount of money with a second user account based on the second user identification information; and instruct a merchant bank to transfer a sum of money to a partner bank, wherein the sum of money includes the first amount of money and the second amount of money.

According to some embodiments, the sum of money can be stored at an FBO account of the partner bank.

According to some embodiments, the transfer from the merchant bank to the partner bank can be performed using ACH.

According to some embodiments, the first POS device and the second POS device can be the same.

According to some embodiments, the first POS device and the second POS device can be different.

According to some embodiments, the module stored in the memory can be further configured to cause the processor to receive a third request to store a third amount of money related to a third transaction between the first user and the second merchant, wherein the third request includes the first user identification information, and wherein the third amount of money is equal to or less than third change due to the first user from the third transaction; and associate the third amount of money with the first user account based on the first user identification information.

According to some embodiments, the merchant and the second merchant can be the same.

According to some embodiments, the merchant and the second merchant can be different.

According to some embodiments, the module stored in the memory can be further configured to cause the processor to calculate a balance of money associated with the first user account, wherein the balance of money includes a sum of the first amount of money and the third amount of money; receive a user request to use the balance of money or a subset of the balance of money, wherein the user request includes a destination to receive the balance of money or the subset of the balance of money; instruct a transfer of the balance of money or the subset of the balance of money from the FBO account to the destination; and calculate an updated balance of money associated with the first user account, wherein the updated balance of money is the balance of money subtracted by the balance of money or the subset of the balance of money that is transferred.

A non-transitory computer readable medium according to one embodiment of the present disclosure can have executable instructions operable to cause an apparatus to: receive, from a first POS device, a first request to store a first amount of money related to a first transaction between a user and a first merchant, wherein the first request includes user identification information uniquely associated with the user, and wherein the first amount of money is equal to or less than first change due to the user from the first transaction; associate the first amount of money with a user account based on the user identification information; receive, from a second POS device, a second request to store a second amount of money related to a second transaction between the user and a second merchant, wherein the second request includes the user identification information, and wherein the second amount of money is equal to or less than second change due to the user from the second transaction; associate the second amount of money with the user account based on the user identification information; calculate a balance of money associated with the user account, wherein the balance of money includes a sum of the first amount of money and the second amount of money; receive a user request to use the balance of money or a subset of the balance of money, wherein the user request includes a destination to receive the balance of money or the subset of the balance of money; and instruct a transfer of the balance of money or the subset of the balance of money from an FBO account to the destination.

According to some embodiments, the non-transitory computer readable medium can further have executable instructions operable to cause an apparatus to transmit data for generating a receipt associated with at least the first request to store the first amount of money or the second request to store the second amount of money.

According to some embodiments, the receipt can be in a form of at least one of an email or a text message.

According to some embodiments, the non-transitory computer readable medium can further have executable instructions operable to cause an apparatus to calculate an updated balance of money associated with the user account, wherein the updated balance of money is the balance of money subtracted by the balance of money or the subset of the balance of money that is transferred.

According to some embodiments, the transfer from the FBO account to the destination can be performed using ACH.

According to some embodiments, the user identification information can be based on user input at the first POS device or the second POS device.

According to some embodiments, the user input can include a phone number.

According to some embodiments, the first merchant and the second merchant can be the same.

According to some embodiments, the first merchant and the second merchant can be different.

According to some embodiments, the first POS device and the second POS device can be the same.

According to some embodiments, the first POS device and the second POS device can be different.

A non-transitory computer readable medium according to one embodiment of the present disclosure can have executable instructions operable to cause an apparatus to: receive, from a first POS device, a first request to store a first amount of money related to a first transaction between a first user and a merchant, wherein the first request includes first user identification information uniquely associated with the first user, wherein the first amount of money is equal to or less than first change due to the first user from the first transaction, and wherein the first request is received within a predetermined period; associate the first amount of money with a first user account based on the first user identification information; receive, from a second POS device, a second request to store a second amount of money related to a second transaction between a second user and the merchant, wherein the second request includes second user identification information uniquely associated with the second user, wherein the second amount of money is equal to or less than second change due to the second user from the second transaction, and wherein the second request is received within the predetermined period; associate the second amount of money with a second user account based on the second user identification information; and instruct a merchant bank to transfer a sum of money to a partner bank, wherein the sum of money includes the first amount of money and the second amount of money.

According to some embodiments, the sum of money can be stored at an FBO account of the partner bank.

According to some embodiments, the transfer from the merchant bank to the partner bank can be performed using ACH.

According to some embodiments, the first POS device and the second POS device can be the same.

According to some embodiments, the first POS device and the second POS device can be different.

According to some embodiments, the non-transitory computer readable medium can further have executable instructions operable to cause an apparatus to receive a third request to store a third amount of money related to a third transaction between the first user and the second merchant, wherein the third request includes the first user identification information, and wherein the third amount of money is equal to or less than third change due to the first user from the third transaction; and associate the third amount of money with the first user account based on the first user identification information.

According to some embodiments, the merchant and the second merchant can be the same.

According to some embodiments, the merchant and the second merchant can be different.

According to some embodiments, the non-transitory computer readable medium can further have executable instructions operable to cause an apparatus to calculate a balance of money associated with the first user account, wherein the balance of money includes a sum of the first amount of money and the third amount of money; receive a user request to use the balance of money or a subset of the balance of money, wherein the user request includes a destination to receive the balance of money or the subset of the balance of money; instruct a transfer of the balance of money or the subset of the balance of money from the FBO account to the destination; and calculate an updated balance of money associated with the first user account, wherein the updated balance of money is the balance of money subtracted by the balance of money or the subset of the balance of money that is transferred.

These and other capabilities of embodiments of the disclosed subject matter will be more fully understood after a review of the following figures, detailed description, and claims.

It is to be understood that both the foregoing general description and the following detailed description are explanatory only and are not restrictive of the claimed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a system for managing information related to transactions in accordance with embodiments of the present disclosure.

FIG. 2 illustrates a block diagram of the POS device in accordance with some embodiments of the present disclosure.

FIG. 3 illustrates a block diagram of a server system that includes the server from FIG. 1 in accordance with some embodiments of the present disclosure.

FIG. 4 illustrates a method of transferring and storing information related to a transaction in accordance with some embodiments of the present disclosure.

FIG. 5 illustrates a method of pooling money from one or more users making transactions with one or more merchants in accordance with some embodiments of the present disclosure.

FIGS. 6A-6D illustrate an example process by which a POS device can be used in a transaction between a user and a merchant in accordance with some embodiments of the present disclosure.

FIG. 7 illustrates a method by which a third-party application can use a server API to leverage functions and features of the server in accordance with some embodiments of the present disclosure.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods and media that are within the scope of the disclosed subject matter.

As described in the Background section, many cash transactions are burdensome because payees or merchants (hereinafter, the term “payee” and “merchant” will be used interchangeably) that accept cash need to return change to the payor. Systems and methods disclosed in the present disclosure can allow customers and merchants to conduct better cash transactions by remitting the loose change digitally, rather than in physical currency, and providing customers with an easy-to-use savings platform. The amount to be remitted can be transferred via the disclosed system that is built with specialized infrastructure to enable frictionless payments—which can be micro payments—from one merchant to one customer. The disclosed system can be built outside of the traditional credit and debit card system, allowing more flexibility and the handling of micro transaction amounts that are central to cash and change. By nature of the older credit card system and limited banking instruments, these transactions could not occur effectively without a new, independent processing system. The disclosed system can sit on top of the existing banking system, utilizing existing tools (e.g., Automated Clearing House (ACH) tools) to cheaply save customers' change from their transactions with merchants of both brick and mortar and non-brick and mortar types.

One of the major benefits of the disclosed system is that transaction costs for customers essentially become zero. Without the disclosed system, customers who use cash have minimal options. Many customers store their change for each and every cash transaction manually, thereafter bringing the accumulated sum into coin conversion kiosks. In contrast, with the disclosed system, customers can benefit in at least three ways: (1) customers no longer have to store their change and worry about losing their coins, (2) customers do not have to spend the time to find and go to a coin conversion machine, and (3) customers pay significantly reduced or no fees for the service. For the disclosed system, a customer can simply provide a minimal amount of information, such as demographic and/or basic account information in order to access the service. The disclosed system is novel in the network and the type of transactions it allows to occur amongst a huge swath of payors and payees.

In addition, merchants dislike change. For merchants, the cost of cash is high, largely attributed to costs associated with carrying and maintaining cash change. Larger merchants spend large amounts of money on armored trucks to bring coins and cash to their stores, resulting in periodic (e.g., daily or weekly) transfers. Also, stocking cash registers with the right denominations often requires the time of a manager and/or cashier at high frequencies. Further, smaller merchants generally make many trips to the local bank, resulting in more time costs. Some merchants have adjusted their menu offerings such that the post-tax amount results in an even number so they do not have to deal with change. However, such adjustments restrict their ability to raise prices reflecting food or other costs, and many do not have the capacity to do so in a dynamic way.

The disclosed system includes hardware and/or software components that enable a transaction that does not exist in any known form and in any other context, allowing merchants to remit cash change to customers in a flexible account format. In some embodiments, the disclosed system can integrate directly onto existing Point-of-Sale (POS) systems. In these embodiments, no additional hardware may be required, and only an application may need to be downloaded and installed.

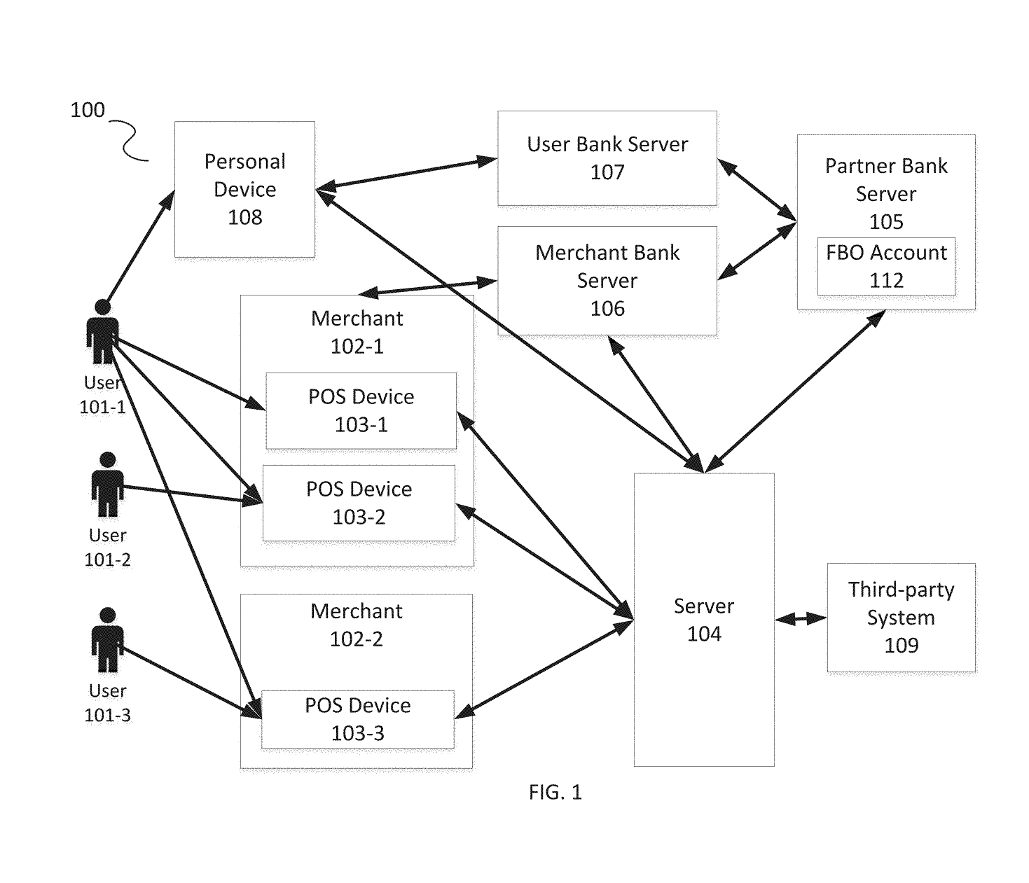

FIG. 1 illustrates a system 100 for managing information related to transactions in accordance with embodiments of the present disclosure. In some embodiments, the information can relate to change due to a user from a transaction between the user and a merchant. For example, if a user buys a product from a merchant for $3.50 and the user gives a five-dollar bill to the merchant, the change due to the user would be $1.50. The system 100 can include at least one POS device (e.g., POS devices 103-1, 103-2, and 103-3), a server 104, a partner bank server 105, a merchant bank server 106, a user bank server 107, a personal device 108, and a third-party system 109. The components included in the system 100 can be further broken down into more than one component and/or combined together in any suitable arrangement. Further, one or more components can be rearranged, changed, added, and/or removed. Actors in the system 100 can include at least one user 101 (e.g., users 101-1, 101-2 and 101-3) and at least one merchant 102 (e.g., 102-1 and 102-2).

According to some embodiments, the user 101 can be a customer of the merchant 102, where both the user 101 and the merchant 102 can use the POS device 103 of the merchant 102 to perform a transaction between the user 101 and the merchant 102. In some embodiments, the merchant 102 can use one or more POS devices. For example, the merchant 102-1 can use POS devices 103-1 and 103-2. In some embodiments, the user 101 can interact with one or more POS devices of a single merchant. For example, the user 101-1 can interact with both the POS devices 103-1 and 103-2 of the merchant 102-1. In some embodiments, the user 101 can interact with different merchants using different POS devices. For example, the user 101-1 can use the POS device 103-1 of the merchant 102-1, the POS device 103-2 of the merchant 102-1, and the POS device 103-3 of the merchant 102-2. In some embodiments, the POS device 103 can be used by one or more users. For example, the POS device 103-2 can be used by the users 101-1 and 101-2. Although the present disclosure uses POS devices as the interface between merchants and users, other suitable systems and/or devices are also within the scope of the invention.

According to some embodiments, one or more POS devices 103 can communicate with the server 104. For example, the merchant 102-1 can establish a connection between the POS device 103-1 and the server 104. In some embodiments, such a connection is established after the merchant provides valid authentication information (e.g., user ID and password) via a user interface of the POS device. As another example, special software on the POS device 103-2 can automatically establish connection between the POS device 103-2 and the server 104. In some embodiments, a server connection that is automatically established can be preloaded onto the POS device via a third party platform. For example, a merchant can be prompted to register for the service at the third party platform. In some embodiments, the special software can be available individually or as part of a package for various systems. The special software or the package can be downloaded onto the POS device and can establish connection with the server 104.

According to some embodiments, a merchant can use a POS device to allow a user to store any change or a subset of change from a transaction between the user and the merchant. For example, if a user buys products that are worth $3.50, and gives the merchant a five-dollar bill, the change due to the user would be $1.50. The user can ask the merchant to store $1.50 or any subset of $1.50 in the server 104. In some embodiments, the server 104 can require the user to have an existing account. In other embodiments, the server 104 can create a new account for the user, if the user does not already have an account in the server 104 or if the user desires to use a new account. The merchant can enter in the user's request to store the change or a subset of the change using the POS device. The merchant can then ask the user to input user identification information that is uniquely associated with the user. For example, the user identification information can be the user's phone number, account number, social security number, student number, employee number, user-created or system-created string, or any other information that can be uniquely associated with the user. Each and every transaction at the merchant 102 can get routed through an Application Program Interface (API) to the server 104. The server 104 can ultimately move the money into a for benefit of (FBO) account at a partner bank, which is associated with the entity that owns or controls the server 104. In some embodiments, users of the server 104 can be restricted to storing change that arise from transactions with merchants.

According to some embodiments, the server 104 can communicate with various types of bank servers. In some embodiments, the server 104 can communicate with a partner bank server 105. A partner bank can be a bank that maintains a relationship with the entity that owns or controls the server 104. For example, if Company X owns and/or controls the server 104, Company X may have a bank account(s) at a partner bank. Company X can access various online banking services via the partner bank server 105. For example, Company X can deposit money, withdraw money, transfer money, receive money (e.g., via a wire transfer, via ACH, via a third-party payment system, etc.), check an account balance, open a new account, close an existing account, modify an existing account, update account properties, and any other banking capabilities that may be provided by the partner bank.

In some embodiments, the server 104 can communicate with a merchant bank server 106. A merchant bank can be a bank that maintains a relationship with a merchant. For example, the merchant 102-1 can have a bank account(s) at the merchant bank that owns or manages the merchant bank server 106. The merchant 102-1 can access various online banking services via the merchant bank server 106. For example, the merchant 102-1 can deposit money, withdraw money, transfer money, receive money (e.g., via a wire transfer, via ACH, via a third-party payment system, etc.), check an account balance, open a new account, close an existing account, modify an existing account, update account properties, and any other banking capabilities that may be provided by the merchant bank.

In some embodiments, each merchant can be required to provide its banking information before being approved to utilize the services provided by the server 104. In some embodiments, after each transaction for the server 104 occurs at the POS device 103, the excess change that is left at the merchant can be, via ACH, debited out of the merchant bank server 106 and into the partner bank server 105. In some embodiments, such debits occur at certain, predetermined intervals. These unique processes can be incorporated into the software/hardware and network of the system 100. In some embodiments, the server 104 can communicate with the merchant bank server 106 to debit money out of the merchant bank and into the partner bank. In some embodiments, the server 104 can communicate with the partner bank server 105, which can then communicate with the merchant bank server 106 to debit money out of the merchant bank and into the partner bank. The deposits can be stored in an FBO account 112, which can be a pooled account, at the partner bank server 105. In some embodiments, the FBO account at the partner bank 105 can be an account that does not get physically separated for each user. The services provided by the server 104 can allow the users to cheaply and securely store their money and subsequently move it into the users' own bank accounts that are located, for example, at the user bank server 107.

A user bank can be a bank that maintains a relationship with the user. For example, the user 101-1 can have a bank account(s) at the user bank that owns or manages the user bank server 107. The user 101-1 can access various online banking services via the user bank server 107. For example, the user 101-1 can deposit money, withdraw money, transfer money, receive money (e.g., via a wire transfer, via ACH, via a third-party payment system, etc.), check an account balance, open a new account, close an existing account, modify an existing account, update account properties, and any other banking capabilities that may be provided by the merchant bank.

In some embodiments, various bank servers can communicate with one or more of the other bank servers. For example, the partner bank server 105 can communicate with the user banks server 107 and/or the merchant bank server 106. In some embodiments, a money transfer between two banks can be performed by ACH, check, wire transfer, credit card, and/or any other suitable mechanism.

According to some embodiments, the user 101-1 can use the personal device 108 to access the server 104 and/or the user bank server 107. In some embodiments, the user 101-1 can use an application on the personal device 108—such an app on a tablet, a software program on a computer, and a web-based program—to connect to the server 104 via an API to use various features that the server 104 provides. For example, the user 101-1 can launch a web browser and navigate to a certain URL that points to the server 104. Alternatively, the user 101-1 can launch a standalone application that is provided to connect to the server 104. The user 101-1 may need to enter in authentication information—such as a user ID, an account number, and/or a password—to log in. After the user 101-1 has logged in, the user 101-1 can use various features that the server 104 provides. These features can include viewing a balance of the stored money, viewing a transaction history, viewing personal information, requesting to use the balance or a subset of the balance, modifying personal information, selecting a destination for cash out, modifying a destination for cash out, selecting timing of cash out, viewing various types of locations (e.g., destination locations where the user can cash out, destination locations where the user has previously cashed out, merchant locations where the user has previously visited to store money, merchant locations where the user can visit to store money), viewing savings projections (e.g., savings projections based on the user's pattern of storing money and/or cashing out money), and/or any other feature or combination of features that may be related to the user account of the user 101-1 at the server 104.

According to some embodiments, a user can view the user's balance and interact with an application that connects to the server 104 only after the user has created an account to register with the server 104. In some embodiments, the user can request to use the balance of money or a subset of the balance of money in various ways by selecting a destination(s) for the money. The destination(s) can be any account, any organization, or any entity. In some embodiments, the destination(s) are associated with the server 104, as they have already set up an arrangement with the server 104 to accept a payment. Such a payment can be accepted via ACH. In some embodiments, the user can request the server 104 to transfer the balance of money or a subset of the balance of money to the user's bank account. For example, if the user 101-1 has a balance of $10.00, the user 101-1 can request to transfer $10.00 or $4.55 of the balance to a bank account of the user 101-1. In this case, once the user 101-1 confirms the request via an application on the personal device 108, the server 104 can instruct the partner bank server 105 to transfer the requested amount of money to the user's bank account at the user bank server 107. After the requested money has been transferred, the user 101-1 can use the personal device 108 to access an online banking system by connecting to the user bank server 107 and check the user's bank account to confirm that the user has received the requested amount of money. In some embodiments, the user 101-1 can request the server 104 to transfer the balance of money or a subset of the balance of money to an entity of the user's choice. In some embodiments, such a request can be made at the personal device 108 or at a device of the destination (e.g., a tablet device at a charity organization, to which the user may wish to donate the balance of the stored money). In some embodiments, the user can log in to the server 104 and access its provided interface to select the destination. In some embodiments, the user's request to transfer money to the destination can direct the server to use API to perform various operations, including communicating with other servers (e.g., third-party systems 109, bank tools provided by banks such as the partner bank server 105, and a third party accepter of money which can be a third-party system 109), running a series of database checks, and confirming that money should be moved from the FBO account 112 to a destination of the user's choice.

According to some embodiments, the server 104 can communicate with at least one third-party system 109, which can include an affiliated or non-affiliated company's server that provides support to the server 104 for payment, marketing, sales, or any other business-related activities.

All components in the system 100 can communicate via a communication network. The communication network can be the interne and/or intranet; secured and/or non-secure; wired and/or wireless; and compatible with any type of protocols, including industry standard protocols, open source protocols, and/or proprietary protocols. The components described in the system 100 can be further broken down into more than one component and/or combined together in any suitable arrangement. Further, one or more components can be rearranged, changed, added, and/or removed. For example, the server 104 can be more than one physical server, where various physical servers can be located at different geographic locations. Any arrows shown in FIG. 1 do not necessarily indicate direct connections. For example, the connection between POS device 103 and the server 104 can be direct in some embodiments; however, in other embodiments, such a connection can be via a network, where there can be many other systems in-between the POS device 103 and the server 104. The system 100 can be scalable, where the number of users 101 can be any number that can be in tens, thousands, millions, or more. In some embodiments, the system 100 can require one or more connections to be secure. For example, the server 104 can require any connection between the POS device 103 or the personal device 108 and the server 104 to be secure by using a secure protocol, such as HTTPS. The system 100 can also require any data related to the server 104 stored at the personal device 108 and/or the POS device 103 to be encrypted.

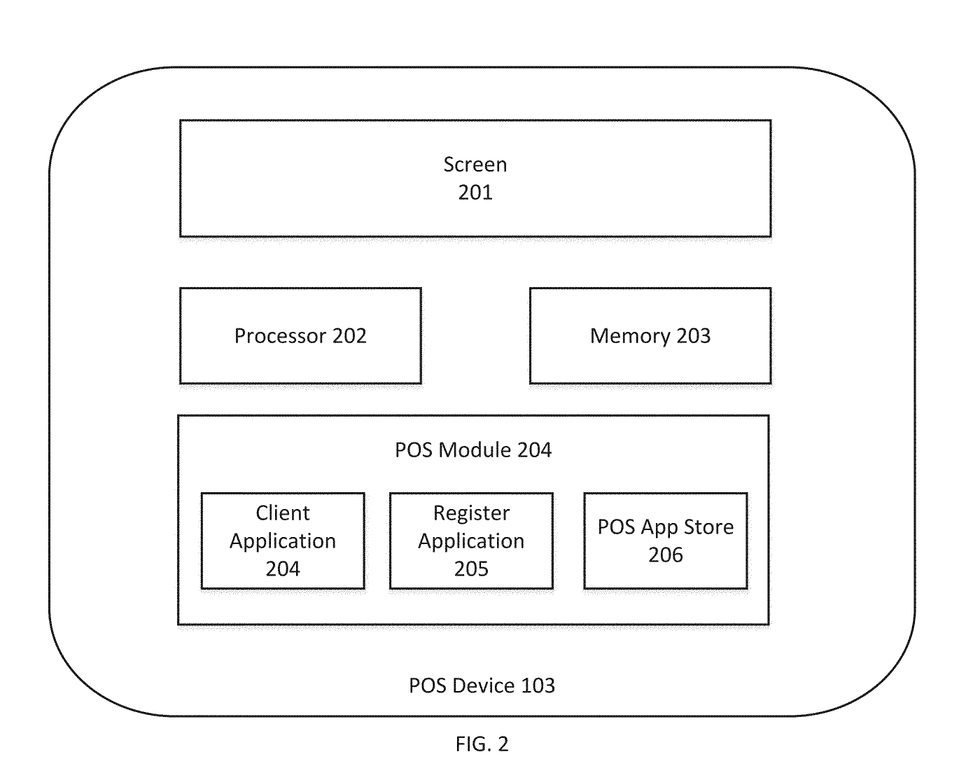

FIG. 2 illustrates a block diagram of the POS device 103 in accordance with some embodiments of the present disclosure. The POS device 103 can include a screen 201, a processor 202, a memory 203, and a POS module 204. The POS device 103 can include additional modules, fewer modules, or any other suitable combination of modules that perform any suitable operation or combination of operations. According to some embodiments, the POS device 103 can be a hardware device with POS software that merchants use to ring up transactions, keep track of inventory, process credit cards and other requirements in order to run a business.

According to some embodiments, the processor 202 can be configured to implement the functionality described herein using computer executable instructions stored in the memory 203, which can be temporary and/or permanent non-transitory memory. The processor 202 can be a general purpose processor and/or can also be implemented using an application specific integrated circuit (ASIC), programmable logic array (PLA), field programmable gate array (FPGA), and/or any other integrated circuit. The processor 202 can execute an operating system (OS) that can be any suitable OS, including a typical OS such as any version or type of Windows, Mac OS, Unix, Linux, VXWorks, Android, Blackberry OS, iOS, Symbian, or other OS.

According to some embodiments, the POS module 204 can include a client application 204, a register application 205, and a POS app store 206. The client application 204 can be used for connecting to and communicating with, the server 104 (FIG. 1). The register application 205 can be used for performing tasks associated with transactions between a merchant and customers (e.g., the user 101 (FIG. 1)). For example, such tasks can include inputting product and price information related to the merchandise products that a customer has purchased, and determining the total amount. In some embodiments, the client application 204 can be combined with or added on top of, an existing register application. In other embodiments, the client application 204 and the register application 205 can be separate but operable in parallel.

The POS module 204 can be configured to cause the processor 202 to execute various features associated with the POS module 204 that are described herein. The POS module 204 can be implemented as software and/or hardware. In some embodiments, the POS module 204 can be implemented in software using the memory 203. The memory 203 can be a non-transitory computer readable medium, flash memory, a magnetic disk drive, an optical drive, a programmable read-only memory (PROM), a read-only memory (ROM), or any other memory or combination of memories.

The POS device 103 can include a screen 201 that can be the interface for the POS device users. In some embodiments, the screen 201 can be a touch screen. In some embodiments, the screen 201 can be the interface for a cashier and a customer of a merchant. For example, cashiers can use the screen 201 to ring up items and process payments. As another example, customers can use the screen 201 for a variety of functions, such as to sign a signature or select a tip option. In some embodiments, the POS device 200 can rotate—for example, in 180 degrees—such that it can turn to face the customer.

Many newer POS devices 200 can allow additions or modifications using applications that have been developed, for example, by third-party developers. Third-party developers can develop their own applications onto a POS network, thereby adding features and functionalities for a merchant whose POS device 200 does not have such features and functionalities. Such features and functionalities can include, for example, coupons, digital comment cards, inventory management, or any other suitable feature/functionality or combination of features/functionalities. A third-party developer can build an application using the code base of the company that builds the POS device 103. Once the application is published on the POS App Store 206, merchants using the particular POS device 103 can download and install the application of their choice.

Many of the older POS devices may not be compatible with applications that are available in an app store and that are built by third-party developers. However, all POS devices can be coded in particular languages so that new features can be integrated if access to the POS devices is provided. In some embodiments, applications or modules of the disclosed system 100 (FIG. 1) that are designed to work with the server 104 (FIG. 1) can be downloaded and installed on many newer POS devices 200. In other embodiments, these applications or modules can also be built and deployed directly onto POS devices, including those of older POS devices that are not set up to download and install third-party applications from the POS app store 206.

According to some embodiments, an API can be provided to allow the POS device 103 to communicate with the server 104. In some embodiments, the server 104 can include various components including a user component and a merchant component. In some embodiments, the user component can determine whether a user has previously used the server 104. In some embodiments, the user component can identify a user that has previously used the server 104. The user component can be dynamic. For example, the user component can allow a merchant to set one or more conditions to reward a specific user or a specific set of users with various types of activities and events, such as offers, discounts, and any other suitable activities and events. In some embodiments, the merchant component can identify the merchant where the transaction occurs, and pairs the identified merchant with the user component. The server 104 can use the merchant component to track data from a POS device(s) of a merchant(s). The server 104 can also use the merchant component to organize the tracked data for reporting and data management purposes. The merchant component can be vital for identifying transaction history, retention of users from first time they visited, and any other suitable purposes. In some embodiments, each communication from the POS device 103 can interact with the user component and/or the merchant component. This communication makes it possible to store change from customers and account for the change in a manner that can easily keep track of and move any amount of money.

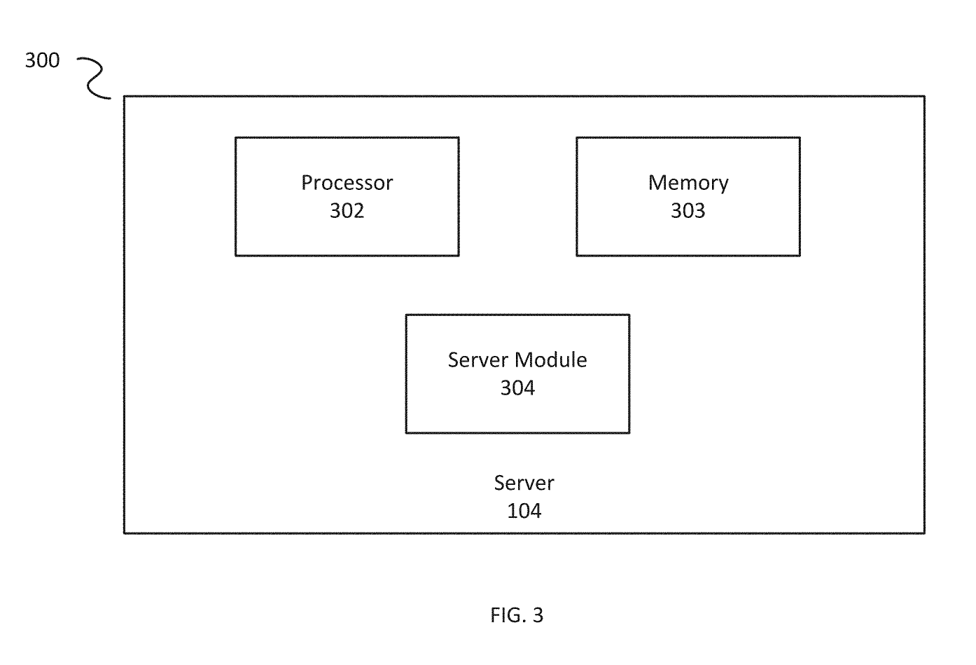

FIG. 3 illustrates a block diagram of a server system 300 that includes the server 104 (FIG. 1) in accordance with some embodiments of the present disclosure. The server 104 can include a processor 302, a memory 303, a server module 304, and a local storage medium 305. The server 104 can also communicate with a remote storage medium 305. The server 104 can include additional modules, fewer modules, or any other suitable combination of modules that perform any suitable operation or combination of operations.

The processor 302 is configured to implement the functionality described herein using computer executable instructions stored in temporary and/or permanent non-transitory memory. The processor can be a general purpose processor and/or can also be implemented using an application specific integrated circuit (ASIC), programmable logic array (PLA), field programmable gate array (FPGA), and/or any other integrated circuit.

The processor 302 can execute an operating system that can be any suitable operating system (OS), including a typical operating system such as any version or type of Windows, Mac OS, Unix, Linux, VXWorks, Android, Blackberry OS, iOS, Symbian, or other OS. The processor 302 can also execute any instructions from web-server related hardware and/or software.

According to some embodiments, the server module 304 can be configured to cause the processor 302 to execute functions related to the features of the server 104 disclosed herein. For example, the server module 304 can be configured to cause the processor 302 to process requests from the POS devices 103 (FIG. 1) and the personal device 108 (FIG. 1). As a specific example, if the POS device 103-1 requests the server 104 to transfer $5 from the change account of the user 101-1 to a destination, the server module 304 can use the processor 302 to execute instructions such that the partner bank server 105 transfers $5 from the FBO account of the partner bank to the bank account of the user 101-1 at the user bank server 107. The server module 304 can then use the processor 302 to execute instructions such that a confirmation message can be sent to the POS device 103-1 regarding the requested transaction. In some embodiments, the server module 304, any part of the server module 304, or any other modules or components within the server 104 can be implemented as software and/or hardware. In some embodiments, the server module 304 can be implemented in software using the memory 303. The memory 303 can be a non-transitory computer readable medium, flash memory, a magnetic disk drive, an optical drive, a programmable read-only memory (PROM), a read-only memory (ROM), or any other memory or combination of memories. In some embodiments, the memory can include a local storage medium and/or a remote storage medium. The memory 303 can include data such as user bank information, merchant bank information, user profiles, merchant profiles, user balances, and history of transactions by users and merchants.

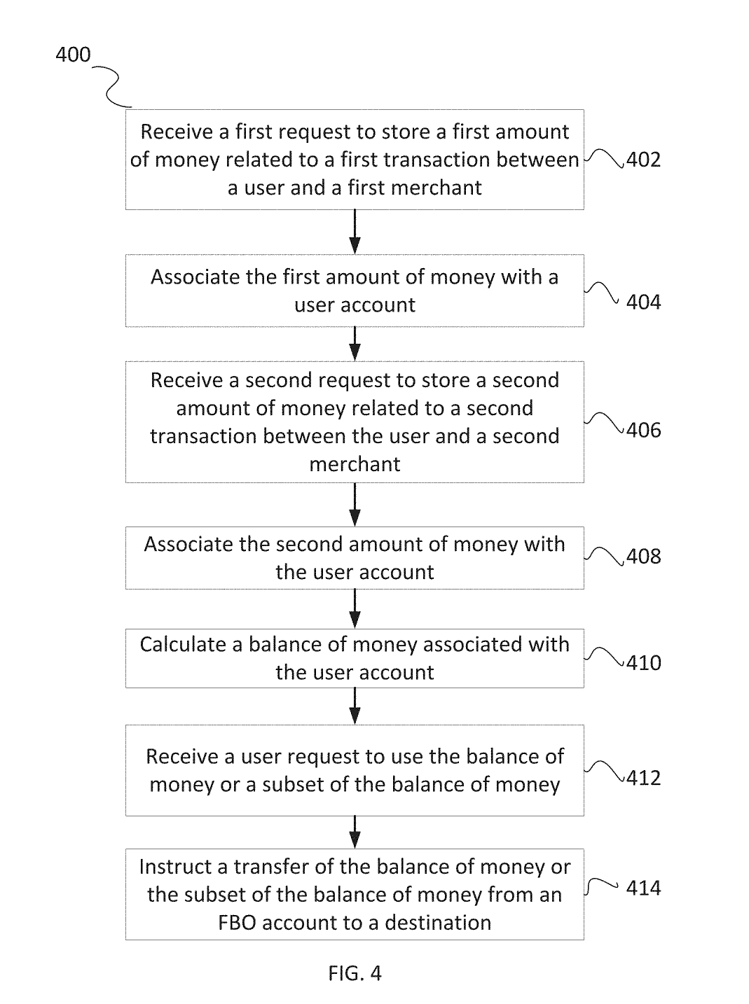

FIG. 4 illustrates a method 400 of transferring and storing information related to a transaction in accordance with some embodiments of the present disclosure. In some embodiments, the method 400 can be modified by, for example, having steps combined, divided, rearranged, changed, added, and/or removed. In some embodiments, the method 400 can be performed at the server module 304 (FIG. 3). In some embodiments, the server module 304 can be located in the server 104 (FIG. 1) or any other suitable location of the system 100 (FIG. 1).

At step 402, a first request to store a first amount of money related to a first transaction between a user (e.g., the user 101-1 (FIG. 1)) and a first merchant (e.g., the merchant 102-1 (FIG. 1)) can be received. In some embodiments, the first request is received at the server 104 from a first POS device (e.g., the POS device 103-1). In some embodiments, the first request can include user identification information uniquely associated with the user. In some embodiments, the first amount of money is equal to or less than first change due to the user from the first transaction. In some embodiments, the user identification information can be based on user input at the POS device. For example, the first merchant may hand over the first POS device to the user to enter the user's identification information such as the user's phone number. As another example, the first merchant may receive the user's identification information and enters it on behalf of the user.

At step 404, the first amount of money can be associated with a user account. Such association can be based on the user identification information. For example, if the first amount of money is $0.37, $0.37 can be associated with the user account at the server 104, where the user account balance can be increased by $0.37.

At step 406, a second request to store a second amount of money related to a second transaction between the user (e.g., user 101-1) and a second merchant (e.g., user 101-2) can be received. In some embodiments, the second request is received at the server 104 from a second POS device (e.g., the POS device 103-3). In some embodiments, the second request can include the user identification information. In some embodiments, the second amount of money is equal to or less than second change due to the user from the second transaction. In some embodiments, the user identification information can be based on user input at the POS device. For example, the second merchant may hand over the second POS device to the user to enter the user's identification information such as the user's phone number. As another example, the second merchant may receive the user's identification information and enters it on behalf of the user.

At step 408, the second amount of money can be associated with the user account. Such association can be based on the user identification information. For example, if the second amount of money is $3.25, then $3.25 can be associated with the user account, where the user account balance can be increased by $3.25.

At step 410, a balance of money associated with the user account can be calculated. In some embodiments, the balance of money includes a sum of the first amount of money and the second amount of money. For example, if the balance of money for the user account prior to the first and second transactions were $1.00, then the balance of money after the first and second transactions would be calculated to be $4.62—which is the sum of $1.00, $0.37, and $3.25.

At step 412, a user request to use the balance of money or a subset of the balance of money can be received. In some embodiments, the user request can include a destination, to which the balance of money or the subset of the balance of money can be received.

At step 414, a transfer of the balance of money or the subset of the balance of money from an FBO account to the destination can be instructed. In some embodiments, the FBO account is a bank account that is set up at the partner bank 105 (FIG. 1). In some embodiments, the transfer from the FBO account to the destination can be performed using Automated Clearing House (ACH).

According to some embodiments, the method 400 can also include a step of transmitting data for generating a receipt associated with the first request to store the first amount of money and/or the second request to store the second amount of money. In some embodiments, the receipt can be in a form of an email and/or a text message. For example, after the example scenario in the step 404 above has been completed, the server 104 can email or text the user with a message such as “You have saved $0.37 at Merchant 102-1 to your account. Your balance is now $1.37. Thank you for your business.”

According to some embodiments, the method 400 can include a step of calculating an updated balance of money associated with the user account, where the updated balance of money is the balance of money subtracted by the balance of money or the subset of the balance of money that is transferred as a result of step 414. For example, if $2.00 had been transferred from the FBO account to the user's bank account, the updated balance of money associated with the user account in the above example scenario would be $2.62.

In some embodiments, the first merchant and the second merchant described above can be the same. In other embodiments, the first merchant and the second merchant described above can be different. In some embodiments, the first POS device and the second POS device can be the same. In other embodiments, the first POS device and the second POS device can be different.

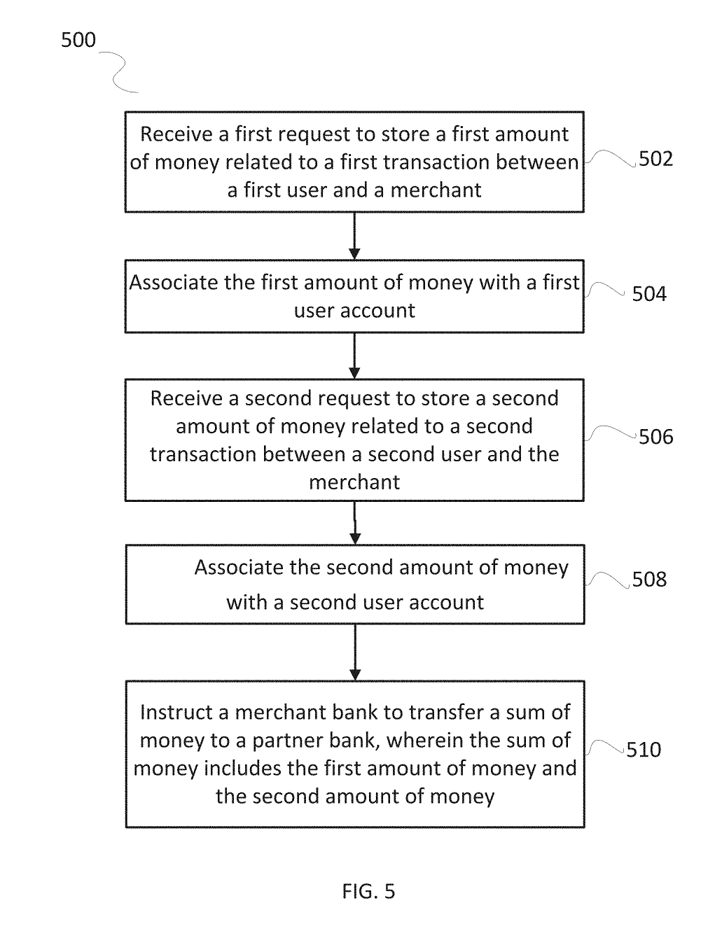

FIG. 5 illustrates a method 500 of pooling money from one or more users making transactions with one or more merchants in accordance with some embodiments of the present disclosure. In some embodiments, the method 500 can be modified by, for example, having steps combined, divided, rearranged, changed, added, and/or removed. In some embodiments, the method 500 can be performed at the server module 304 (FIG. 3). In some embodiments, the server module 304 can be located in the server 104 (FIG. 1) or any other suitable location of the system 100 (FIG. 1).

At step 502, a first request to store a first amount of money related to a first transaction between a first user (e.g., the user 101-1 (FIG. 1)) and a merchant (e.g., the merchant 102-1 (FIG. 1)) can be received. In some embodiments, the first request is received at the server 104 from a first POS device of the merchant (e.g., the POS device 103-1). In some embodiments, the first request can include user identification information uniquely associated with the user. In some embodiments, the first amount of money is equal to or less than first change due to the first user from the first transaction. In some embodiments, the user identification information can be based on user input at the POS device. For example, the merchant may hand over the first POS device to the user to enter the user's identification information such as the user's phone number. In some embodiments, the first request can be received within a predetermined period. For example, a predetermined period can be set to be any amount of time, such as 5 second, 30 minutes, 5 hours, 3 days, 2 weeks, 1 month, or any other amount of time.

At step 504, the first amount of money with a user account can be associated. Such association can be based on the user identification information. For example, if the first amount of money is $0.50, $0.50 can be associated with the user account, where the user account balance can be increased by $0.50.

At step 506, a second request to store a second amount of money related to a second transaction between a second user (e.g., the user 101-2 (FIG. 1)) and the merchant (e.g., the merchant 102-1 (FIG. 1)) can be received. In some embodiments, the second request is received at the server 104 from a second POS device of the merchant (e.g., the POS device 103-2). In some embodiments, the second request can include second user identification information uniquely associated with the second user. In some embodiments, the second amount of money is equal to or less than second change due to the second user from the second transaction. In some embodiments, the second user identification information can be based on second user input at the POS device. For example, the merchant may hand over the second POS device to the second user to enter the second user's identification information such as the second user's phone number. In some embodiments, the second request can be received within the predetermined period.

At step 508, the second amount of money can be associated with a second user account. Such association can be based on the second user identification information. For example, if the second amount of money is $1.55, $1.55 can be associated with the second user account, where the second user account balance can be increased by $1.55.

At step 510, a merchant bank can be instructed to transfer a sum of money to a partner bank. In some embodiments, the sum of money can include the first amount of money and the second amount of money. For example, in the above example scenarios, the sum of money can be at least $2.05, which includes the amount of $0.50 from the first transaction and the amount of $1.55 from the second transaction. In some embodiments, the sum of money can be stored at an FBO account of the partner bank. In some embodiments, the transfer from the merchant bank to the partner bank can be performed using ACH. In some embodiments, the first POS device and the second POS device described above can be the same. In other embodiments, the first POS device and the second POS device can be different.

According to some embodiments, the method 500 can include a step of receiving a third request to store a third amount of money related to a third transaction between the first user and a second merchant. In some embodiments, the third request can include the first user identification information. In some embodiments, the third amount of money is equal to or less than third change due to the first user from the third transaction. In some embodiments, the third amount of money can be associated with the first user account based on the first user identification information. In some embodiments, the merchant and the second merchant described above can be the same. In other embodiments, the merchant and the second merchant described above can be different.

According to some embodiments, the method 500 can include a step of calculating a balance of money associated with the first user account. In some embodiments, the balance of money can include a sum of the first amount of money and the third amount of money. In some embodiments, the method 500 can include a step of receiving a user request to use the balance of money or a subset of the balance of money. In some embodiments, the user request can include a destination to receive the balance of money or the subset of the balance of money. In some embodiments, the method 500 can include a step of instructing a transfer of the balance of money or the subset of the balance of money from the FBO account to the destination. In some embodiments, the method 500 can include a step of calculating an updated balance of money associated with the first user account. In some embodiments, the updated balance of money can be the balance of money subtracted by the balance of money or the subset of the balance of money that is transferred.

According to some embodiments, an amount of money related to a transaction at a merchant can be transferred from the partner bank to the user bank before the amount of money has been transferred from the merchant bank to the partner bank. An example is provided to illustrate this case. At 9 AM, a user makes a transaction at a merchant and requests the merchant to store change in the amount of $2.50 at the server. At 9:05 AM, the user logs into the user's personal device and requests the server to transfer $2.50 (the full balance of the user account at the server) from the partner bank to the user's bank account at the user bank. The server fulfills the user request. At 12 PM, a sum of money, including the amount of $2.50 associated with the user, is transferred from the merchant bank to the partner bank. In this case, the entity that owns or manages the server bears credit risks associated with the $2.50 between 9:05 AM and 12 PM.

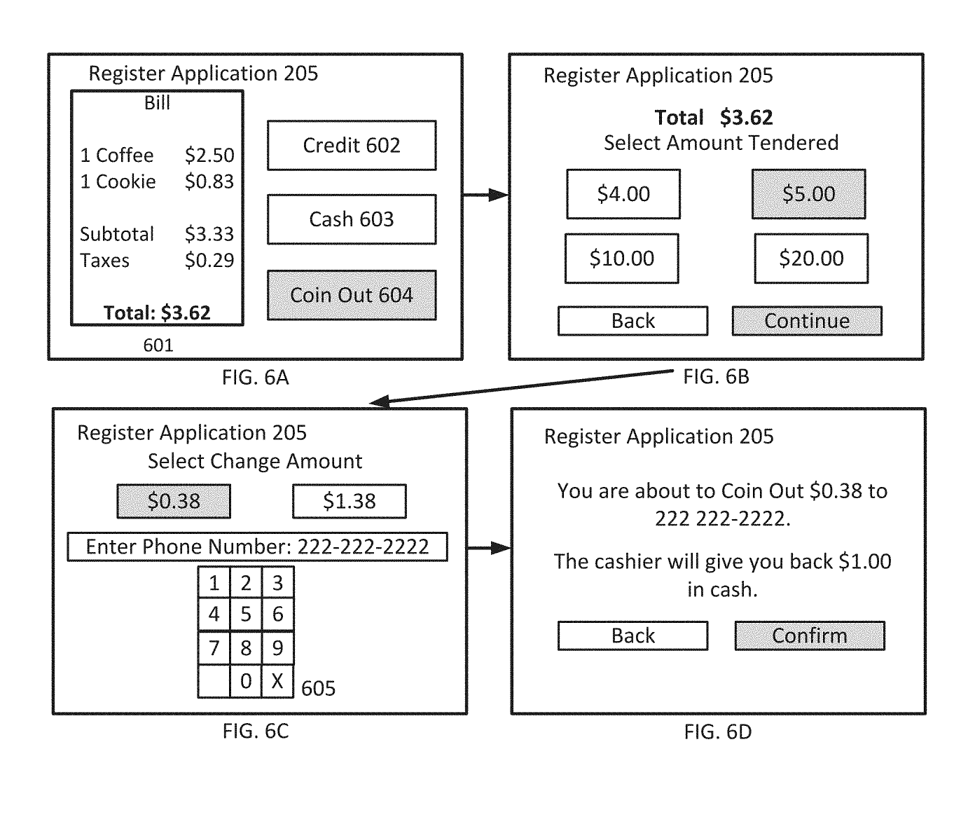

FIGS. 6A-6D illustrate an example process by which a POS device can be used in a transaction between a user and a merchant in accordance with some embodiments of the present disclosure. Each of FIGS. 6A-6D can represent a different screen view on the POS device. In some embodiments, the screen view is shown via the screen 201 (FIG. 2).

In FIG. 6A, a cashier of a merchant can ring up a transaction on the register application 205 (FIG. 2) for a customer. As shown in a box 601 within the screen, the customer has bought a single item of coffee and a single item of cookie, whose total come to $3.62. Depending on how the customer decides to pay, the cashier can select from various options, including Credit 602, Cash 603, and Coin Out 604. The cashier can select Credit 602 if the customer wants to pay with a credit card. The cashier can select Cash 603 if the customer wants to pay with cash and receive any change in cash. The cashier can select Coin Out 604 if the customer wants to “coin out” or store any change in the server 104 (FIG. 1). For example, the customer can ask the cashier to coin out, while handing the cashier a cash denomination. The cashier can then press the Coin Out button 604, and the screen will move to the screen as shown in FIG. 6B.

In FIG. 6B, the register application 205 can automatically provide possible cash denominations the customer might give, and the cashier can simply select which amount has been handed over. For example, if the customer has given a five-dollar bill to the cashier, the cashier can press the $5.00 button, which would highlight the $5.00 button as shown in FIG. 6B. Once the cashier presses “continue,” the screen moves to FIG. 6C.

The cashier can pivot the POS device or the touch screen part of the POS device to the customer (e.g., by a simple rotation) such that the customer can input information related to the customer's account at the server 104. In other embodiments, an external screen can exist on a separate screen or device, thereby eliminating the need to rotate the screen. When the screen is rotated to the customer, the customer may be prompted to enter his or her phone number using a keypad 605 provided as shown in FIG. 6C. This process advantageously does not require a customer to sign up before using the product or download an application on his or her own personal device. The customer can then enter his or her phone number and then has the option to select how much change the customer would like to store at the server 104. If the amount is above a certain amount (e.g., above $1.00, such as $1.38), the customer may have the option to select from more than one amount (e.g., $0.38 or $1.38). If the amount is $1.00 or below (e.g., $0.38), there may only be one amount (e.g., $0.38). Once the customer selects the amount (e.g., $0.38), the screen then goes to FIG. 6D as a confirmation step. This screen shows the phone number entered and the change selected. If there is dollar change to be given back (e.g., as in the example here where $1 is due back), then the screen can indicate that the cashier needs to give $1 back. Once the customer presses the “Confirm” button, the transaction is complete. In some embodiments, the process returns to the starting state after the customer confirms.

After the transaction is complete, the customer can receive a text message (e.g., an SMS message) or email receipt of the transaction and a link to create an account with the server 104 if the user does not already have an account.

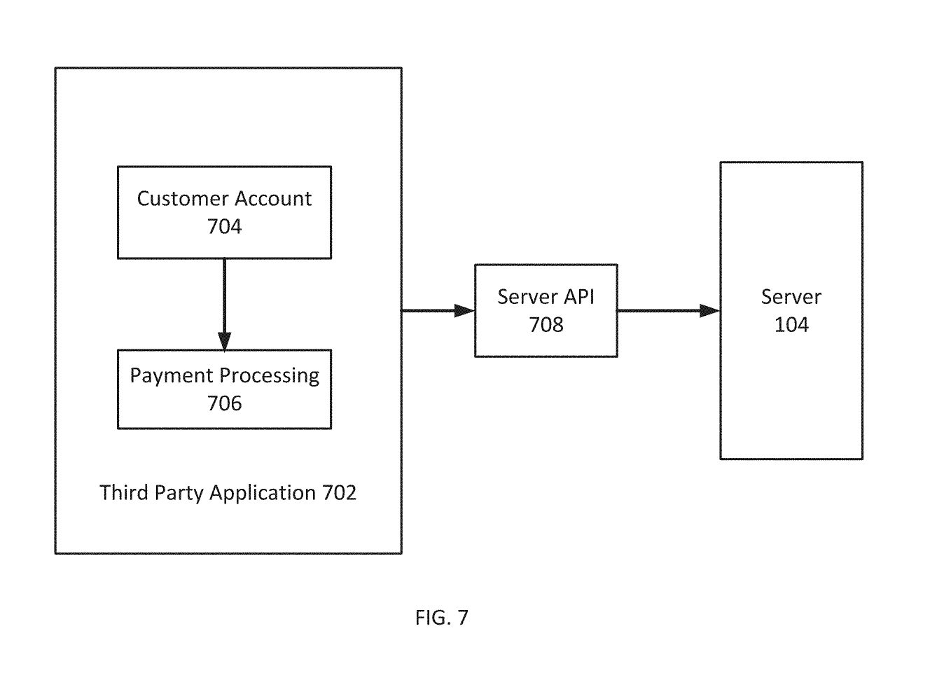

FIG. 7 illustrates a method by which a third-party application 702 can use a server API 708 provided by the disclosed system 100 (FIG. 1) to leverage functions and features of the server 104 in accordance with some embodiments of the present disclosure. Although this method can be used in any context, it is particularly useful for many service providers in the non-brick and mortar context that accept payments through a variety of different services. With these third party applications, a transaction can occur directly in the third party application 702 with the customer account 704 linking with payment processing 706 that involves a card-based method of payment (e.g., credit card, debit card, gift card). Such third party applications by themselves cannot be used for processing cash transactions that can avoid cash change.

According to some embodiments, the server API 708 can be integrated directly with these third-party applications 702 such that the service providers do not need to carry change and can execute cash transactions with the disclosed system 100 (FIG. 1). The server API 708 can be built to allow the third-party service provider to decide how the third-party service provider can allow its customers to store their change and subsequently use it. For example, some third-party service providers may want to allow customers to store the change only as store credit to apply to a future purchase. These third-party service providers can achieve such a goal using one or more of at least three different ways. First, a separate FBO account can be established to store change that can be used only as store credit. The server 104 can be configured to use the separate FBO account. Second, a third-party service provider can hold onto the change without passing the money to an FBO account at the partner bank. Third, store credit may not be obligatory but can be provided as an appealing option. For example, a customer's change can be stored in an FBO account but the customer is charged extra to move the money in the FBO account to any other destination beside the merchant where the change originated.

An example of how the disclosed system 100 (FIG. 1) can work outside of the conventional POS context can be shown with transportation services, such as limousine, cab, or other car services. Many limousine and cab drivers act as merchants when accepting fares from their riders. Most limousine and cab companies enable riders to hail drivers using a smartphone application, rather than the traditional method of calling for a car or hailing a driver with a raised hand. For riders who use the smartphone application, payment can generally be processed only through card-based transactions, as riders can only use the hailing feature once they add a credit card or debit card to their account. In this scenario, both the driver and rider have a third party application 702 on their phone or another device to execute the transaction in the vehicle. The transaction happens automatically after the rider or driver “terminates” the trip when the destination is reached. With integration of features from the disclosed system 100 (FIG. 1) into the third party application 702, the rider may be able to pay the driver with cash, and the driver would be able to remit the change through the third party application 702—using the server API 708—rather than in physical change. The driver can provide his or her device with the third party application 702 to the rider, who would in turn provide his or her phone number and receive the change via the disclosed system 100 (FIG. 1). This example is not limited to transportation services and can be applied to any other industry or service provider. For instance, this example can be applied to food delivery systems using mobile applications. Many of these companies have decided not to accept cash. Many companies in other industries using similar systems have also decided not to accept cash. These companies can benefit from using the disclosed system 100.

Another example can involve casual payees or small vendors, such as at food stands, farmer's markets, food trucks, flea markets and other payees that do not have the capacity to set up a full cash register system. The disclosed system and methods make the small merchant's task of accepting a cash payment easier and cheaper. In this context, rather than having to obtain coinage, the small merchant could download an individual application provided by the disclosed system 100 (FIG. 1) onto its smartphone. Here, the transaction would occur in a very similar method as described above on the POS device. The merchant can simply need to input the change amount to be transmitted to the customer, and the customer thereafter can enter his or her phone number into the merchant's smartphone application. The transaction can be executed in much the same way as described above on the POS device, although the application would not have to exist on top of an existing POS device. Thus, any causal seller can benefit from interacting with cash consumers, while lowering or eliminating costs associated with maintaining cash.

Another application of the disclosed systems and methods can be in the e-commerce context. The disclosed systems and methods can enable merchants to remit any amount of money to customers for the purpose of rewards, incentives, or other reasons. In many cases, merchants maintain reward programs that give customers incentives to buy products at certain times, over certain thresholds, or at certain frequencies. Rewards can often be utilized only with conditions attached. A reward program can enable customers to “spend” the points in exchange for discounts, store credit, or other related promotions. However, merchants typically do not allow customers to liquidate these accrued points for cash value. This is largely because the merchants rely on their store credit system, as most e-commerce companies are only set up to sell products and do not have systems in place to dynamically reward customers. The disclosed systems and methods can give any merchant the option to offer its customers to turn accrued points, status, number of purchases, and any other attributes associated with the customers into cash equivalent value that can be sent to their bank accounts. By integrating the disclosed systems and methods, e-commerce merchants can set conditions, triggers and thresholds for when a customer's points would be “released” as the cash-equivalent. The flexibility of the disclosed system can enable merchants to deploy a new form of reengagement with their customers, and can do so cost effectively outside of the existing credit card structure. For example, if a customer reaches 1000 points, a merchant can determine that the 1000 points are worth $10. The customer reaching 1000 points can be a trigger that causes $10 to be automatically applied to the customer's profile with the merchant. The customer can decide to receive and store that in an account in the disclosed system (e.g., the server 104 (FIG. 1)). This flow is different from traditional refund flows associated with product returns. The traditional refund flows leverage a credit card structure, where the merchant instructs its credit card processor to execute the refund transaction, which then goes through the credit card switch that can indicate to the merchant bank that a refund should be issued to the customer's credit card. Alternatively, a merchant can give back a gift card or store credit in the same value. While such refund flows work for returns, they cannot be enabled in a way that can incentivize and reward customers for their past loyalty. Moreover, many merchants have accrued points that are considered to be liabilities to their customers. By using the disclosed systems and methods, merchants can offer precise liquidation periods or events, where customers can choose to turn their points into cash and deposit the cash into their bank accounts. As a result, merchants can remove their liabilities from their books. Thus, the disclosed system can trigger transactions and balances to push money in a unique funds flow that is opposite to typical trade, which involves the customer sending money to the merchant. The disclosed systems and methods can facilitate the opposite flow for any amount of money (including micro amounts) in ways that are dynamic and with limited identifiers needed for those involved.

Yet, another application of the disclosed systems and methods can be in the coin conversion context. Many coin conversion machines can give customers several options to receive the value back from depositing their coins with the kiosk. For example, certain existing kiosks may allow customers to receive physical cash in a store, receive a digital gift card, or donate to charity in exchange for depositing coins into the kiosks. If a customer chooses to receive physical cash, the customer would receive a printed voucher with a bar code. The customer can then bring the voucher to the clerk at the store who scans the voucher and gives the customer the cash value minus a fee. This is not ideal for the customer because the customer has to bring coins to the kiosk, finish the transaction, go into the store, wait in another line at the register, and pay a fee before receiving the cash value. The disclosed systems and methods can enable existing kiosks to offer a more convenient option to the customer. For example, kiosk companies can utilize the disclosed systems and methods such that a customer depositing coins into the kiosk can choose to receive the cash equivalent value (minus a fee determined by the kiosk companies) to a supported digital account, such as the customer's bank account. The disclosed systems and methods have been built to be highly flexible.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter.

Although the disclosed subject matter has been described and illustrated in the foregoing exemplary embodiments, it is understood that the present disclosure has been made only by way of example, and that numerous changes in the implementation of the disclosed subject matter may be made without departing from the spirit and scope of the disclosed subject matter.

What is claimed is:

1. A method of transferring and storing information related to a transaction, comprising:
receiving, at a server from a first Point of Sale (POS) device, a first request to store a first amount of money related to a first transaction between a user and a first merchant, wherein the first request includes user identification information uniquely associated with the user, and wherein the first amount of money is equal to or less than first change due to the user from the first transaction;
associating, at the server, the first amount of money with a user account based on the user identification information;
receiving, at the server from a second POS device, a second request to store a second amount of money related to a second transaction between the user and a second merchant, wherein the second request includes the user identification information, and wherein the second amount of money is equal to or less than second change due to the user from the second transaction;
associating, at the server, the second amount of money with the user account based on the user identification information;
calculating, at the server, a balance of money associated with the user account, wherein the balance of money includes a sum of the first amount of money and the second amount of money;
receiving, at the server, a user request to use the balance of money or a subset of the balance of money, wherein the user request includes a destination to receive the balance of money or the subset of the balance of money; and
instructing, from the server, a transfer of the balance of money or the subset of the balance of money from a for benefit of (FBO) account to the destination.

2. The method of claim 1 further comprising transmitting, from the server, data for generating a receipt associated with at least the first request to store the first amount of money or the second request to store the second amount of money.

3. The method of claim 2, wherein the receipt is in a form of at least one of an email or a text message.

4. The method of claim 1 further comprising calculating, at the server, an updated balance of money associated with the user account, wherein the updated balance of money is the balance of money subtracted by the balance of money or the subset of the balance of money that is transferred.

5. The method of claim 1, wherein the transfer from the FBO account to the destination is performed using Automated Clearing House (ACH).

6. The method of claim 1, wherein the user identification information is based on user input at the first POS device or the second POS device.

7. The method of claim 6, wherein the user input comprises a phone number.

8. The method of claim 1, wherein the first merchant and the second merchant are the same.

9. The method of claim 1, wherein the first merchant and the second merchant are different.

10. The method of claim 1, wherein the first POS device and the second POS device are the same.

11. The method of claim 1, wherein the first POS device and the second POS device are different.

12. A method of pooling money from one or more users making transactions with one or more merchants, comprising:
receiving, at a server from a first Point of Sale (POS) device of a merchant, a first request to store a first amount of money related to a first transaction between a first user and the merchant, wherein the first request includes first user identification information uniquely associated with the first user, wherein the first amount of money is equal to or less than first change due to the first user from the first transaction, and wherein the first request is received within a predetermined period;
associating, at the server, the first amount of money with a first user account based on the first user identification information;
receiving, at the server from a second POS device of the merchant, a second request to store a second amount of money related to a second transaction between a second user and the merchant, wherein the second request includes second user identification information uniquely associated with the second user, wherein the second amount of money is equal to or less than second change due to the second user from the second transaction, and wherein the second request is received within the predetermined period;
associating, at the server, the second amount of money with a second user account based on the second user identification information; and
instructing, from the server, a merchant bank to transfer a sum of money to a partner bank, wherein the sum of money includes the first amount of money and the second amount of money.

13. The method of claim 12, wherein the sum of money is stored at a for benefit of (FBO) account of the partner bank.

14. The method of claim 12, wherein the transfer from the merchant bank to the partner bank is performed using Automated Clearing House (ACH).

15. The method of claim 12, wherein the first POS device and the second POS device are the same.

16. The method of claim 12, wherein the first POS device and the second POS device are different.

17. The method of claim 13 further comprising:
receiving, at the server from a third POS device of a second merchant, a third request to store a third amount of money related to a third transaction between the first user and the second merchant, wherein the third request includes the first user identification information, and wherein the third amount of money is equal to or less than third change due to the first user from the third transaction; and
associating, at the server, the third amount of money with the first user account based on the first user identification information.

18. The method of claim 17, wherein the merchant and the second merchant are the same.

19. The method of claim 17, wherein the merchant and the second merchant are different.

20. The method of claim 17 further comprising:
calculating, at the server, a balance of money associated with the first user account, wherein the balance of money includes a sum of the first amount of money and the third amount of money;
receiving, at the server, a user request to use the balance of money or a subset of the balance of money, wherein the user request includes a destination to receive the balance of money or the subset of the balance of money;
instructing, from the server, a transfer of the balance of money or the subset of the balance of money from the FBO account to the destination; and
calculating, at the server, an updated balance of money associated with the first user account, wherein the updated balance of money is the balance of money subtracted by the balance of money or the subset of the balance of money that is transferred.

21. A server for transferring and storing information related to a transaction, comprising:
a memory that stores a module; and
a processor configured to run the module stored in the memory that is configured to cause the processor to:
receive a first request to store a first amount of money related to a first transaction between a user and a first merchant, wherein the first request includes user identification information uniquely associated with the user, and wherein the first amount of money is equal to or less than first change due to the user from the first transaction;
associate the first amount of money with a user account based on the user identification information;
receive a second request to store a second amount of money related to a second transaction between the user and a second merchant, wherein the second request includes the user identification information, and wherein the second amount of money is equal to or less than second change due to the user from the second transaction;
associate the second amount of money with the user account based on the user identification information;
calculate a balance of money associated with the user account, wherein the balance of money includes a sum of the first amount of money and the second amount of money;
receive a user request to use the balance of money or a subset of the balance of money, wherein the user request includes a destination to receive the balance of money or the subset of the balance of money; and
instruct a transfer of the balance of money or the subset of the balance of money from a for benefit of (FBO) account to the destination.

22. A non-transitory computer readable medium having executable instructions operable to cause an apparatus to:
receive a first request to store a first amount of money related to a first transaction between a user and a first merchant, wherein the first request includes user identification information uniquely associated with the user, and wherein the first amount of money is equal to or less than first change due to the user from the first transaction;
associate the first amount of money with a user account based on the user identification information;
receive a second request to store a second amount of money related to a second transaction between the user and a second merchant, wherein the second request includes the user identification information, and wherein the second amount of money is equal to or less than second change due to the user from the second transaction;
associate the second amount of money with the user account based on the user identification information;
calculate a balance of money associated with the user account, wherein the balance of money includes a sum of the first amount of money and the second amount of money;
receive a user request to use the balance of money or a subset of the balance of money, wherein the user request includes a destination to receive the balance of money or the subset of the balance of money; and
instruct a transfer of the balance of money or the subset of the balance of money from a for benefit of (FBO) account to the destination.
